(19) United States
(12) Patent Application Publication
(10) Pub. No.: US 2011/0147079 A1
(43) Pub. Date: Jun. 23, 2011

(54) Tension-Resistant Electrical Conductor

(76) Inventor: Wolfgang Dlugas, Wipperfurth (DE)

(21) Appl. No.: 12/969,320

(22) Filed: Dec. 15, 2010

(30) Foreign Application Priority Data
Dec. 22, 2009 (DE) 10 2009 060 419.7

(51) Int. Cl. H01B 3/30; H01B 5/00; H02G 15/02

(52) U.S. Cl. 174/74 R; 174/130; 174/126.2; 174/110 SR

(57) ABSTRACT

A tension-resistant electrical conductor includes a central core wire and at least a first inner wire layer and a second outer wire layer arranged over the central core wire. The central core wire is made of copper or a copper alloy. The first inner wire layer includes, in the circumferential direction, an alternating sequence of copper wires and wires having higher tensile strength, arranged over the central core wire, and the second outer wire layer, and any further outer wire layer, is composed exclusively of copper wires.

This application claims the benefit of German Patent Application No. 10 2009 060 419.7 filed on Dec. 22, 2009, which is hereby incorporated by reference.

### TECHNICAL FIELD

The present invention relates to a tension-resistant electrical conductor, comprising a central core wire and at least two wire layers arranged over the core wire.

### BACKGROUND ART

A conductor is described, for example, in EP 2096645 A1, where the desired tensile strength is achieved by a layer of steel wires, which is arranged over a core wire, which is made of copper. Such a conductor, having suitable insulation, is notably intended for use in wiring or sensor lines in the automotive industry, where small cross-sections, and consequently advantageous bending properties, as well as high flexibility and high tensile strength, are important.

However, particularly in the field of sensor lines that serve, for example, as supply lines for so-called lambda sensors in the catalytic converters of motor vehicles, there is an increasing demand for these lines to be designed so they can be closed in a gas-tight manner at the ends thereof, for example, when a selected end of the line is finished with what is referred to as a crimp contact. If, to this end, after the conductor insulation has been removed, the conductor wires are pressed together by placing a contact sleeve around them, in a well-known manner, the known closed steel wire layer, which is arranged over the core wire, forms a supporting arch, which prevents all of the wires, including the core wire, from being pressed together. This results in channels, which run longitudinally within the conductors and, under the effect of moisture from the outside, may result in corrosion of the conductor, and in reduced flexibility caused by the closed steel wire layer.

### DISCLOSURE OF THE INVENTION

It is therefore an object of the invention to configure the conductor of an electrical cable, or of a line, having small external dimensions, so that it is highly flexible, yet resistant to tension, and so that it can be closed in a gas-tight manner without difficulty by a simple crimp connection, which is considered to be particularly efficient in current connection technology.

This object is achieved according to the invention by arranging a first inner wire layer comprising, in the circumferential direction, an alternating sequence of copper wires and wires having higher tensile strength, over a central core wire made of copper, or a copper alloy, and producing a second, or any further, outer wire layer exclusively from copper wires. With a conventional arrangement of six wires in the first wire layer of a so-called stranded conductor, this means that, as differs from known conductors, the wires having greater tensile strength are arranged in a star shape in the conductor strand, and thus allow for greater flexibility, without detracting from the required tensile strength. Where special value is increasingly set on a reduced weight, as is the case in aviation, the electrical conductors configured according to the invention are of particular importance.

Another particular advantage of the invention is that, as a result of deformation of the softer copper wires when radial pressing force is applied from the circumference, all hollow spaces in the conductor are filled in, all the way to the core wire, whereby, for example, a stripped, which is to say bared, conductor end can be closed in a gas-tight manner. According to the invention, subsequent to compacting the conductor, the wires having greater tensile strength are substantially embedded in a copper matrix. In addition to the gas tightness of the conductor end, it is also important that the copper matrix provides an extremely good and lasting electrical-contact connection with the surrounding connecting part, such as a crimp contact. Such a conductor can therefore be particularly advantageously employed where there is a particular need for electrical supply cables or lines to provide flexibility, tensile strength, and corrosion resistance, while also providing reliable contact, such as in the automotive field, or in aeronautical engineering.

The wires having greater tensile strength can be, for example, high-alloyed copper wires, but in general, when carrying out the invention, steel wires will be employed, and particularly wires made of stainless steel, which exhibit even greater tensile strength and, in the case of stainless steel, are corrosion-resistant. A stranded conductor configured in this way demonstrates a tensile force of at least 200 N.

In a further aspect of the invention, the copper wire that is used as the core wire and the wires made of copper that are arranged in the individual wire layers may be bare copper wires, however it has proven to be particularly advantageous to employ nickel-plated, tin-plated, or silver-plated copper wires for the purpose of the invention.

Depending on the intended use, the electrical conductor according to the invention may comprise a wide variety of insulators over the outermost copper wire layer. For example, the insulator may comprise polyvinylchloride (PVC), polyethylene (PE), a rubber or silicone-rubber material, or a polyetherketone based polymer (PEK, PEEK, PEKK). If there is an elevated demand for corrosion resistance and resistance to corrosive media such as oils and greases, as in the case of automotive engineering, in a further aspect of the invention, the use of fluoropolymers will be more common as the insulating material for the electrical conductor. Such fluoropolymers may be polymers that deform under heat, such as perfluoroalkoxy copolymers (PFA), fluorinated ethylene propylene (FEP), ethylene tetrafluoroethylene (ETFE), tetrafluoroethylene-perfluoroalkyl vinyl ether copolymers (TFA/PFA) or similar fluoropolymers.

However, if the insulating material is to cover a broad temperature range, including both very low and very high temperatures, a fluoropolymer that cannot be deformed under heat will be employed according to the invention. This is a polytetrafluoroethylene (PTFE), or a polytetrafluoroethylene modified by additives, provided this modified polytetrafluoroethylene cannot be deformed under heat.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings, which are given by way of illustration only, and thus are not limitative of the present invention, and wherein:

FIG. 1 shows a sectional view of an electrical cable; and

FIG. 2 shows a sectional view of a crimped connector end.

### DESCRIPTION OF THE EMBODIMENTS

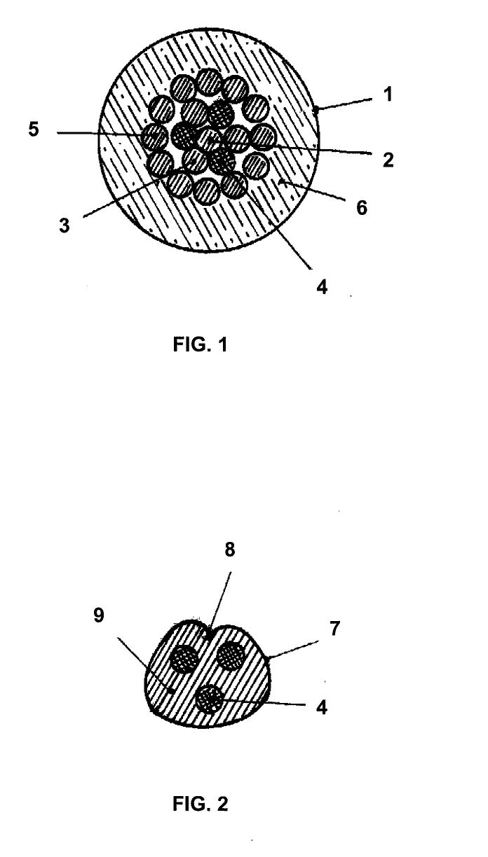

The invention will be described in more detail with reference to the exemplary embodiments shown in FIGS. 1 and 2.

FIG. 1 shows a sectional view of an electrical cable 1, for example serving as a connecting line for a lambda sensor provided in a motor vehicle. The electrical conductor of this cable 1, according to the invention, comprises a central core wire 2 made of copper. Six individual wires are arranged in a first layer over this core wire 2, wherein these individual wires are configured as copper wires 3 and as steel wires 4, which alternate in succession in the circumferential direction. This results in a star-shaped arrangement of the tension-resistant, and thus somewhat rigid, steel wires 4, and therefore minimally impairs the flexibility of the extremely thin cable. A further twelve copper wires 5 are arranged in a second wire layer which, in the exemplary embodiment, form the outermost wire layer, to which an insulator 6 is finally applied. In the illustrated embodiment, the diameters of the core wire 2, the copper wires 3 and 5, and the steel wires 4 is 0.16 mm, resulting in a total conductor diameter of only approximately 0.75 mm. If, as in the present case, the cable 1 serves as a supply line for a lambda sensor, and the conductor insulator 6 is thus advantageously made of polytetrafluoroethylene (PTFE), this results in a total diameter of only approximately 1.31 mm for the cable according to the invention.

If, as already indicated above, a crimp contact having a contact tab is to be attached to one or both ends of the cable 1, in order to electrically connect a load, a crimp barrel is placed around the stripped conductor end, which is to say the end that has been bared of the insulator 6, and the barrel is pressed together with the conductor end.

FIG. 2 shows the crimped conductor end 7, comprising the crimp contact 8 and a copper matrix 9 that results from pressing the copper wires 2, 3 and 5, wherein the steel wires 4 are embedded in this matrix. Although the steel wires 4 are embedded in order to achieve the required tensile strength, the crimp connection according to the invention is gas-tight, and consequently corrosion-resistant. This specific design of the electrical conductor, and the subsequent deformation of the crimped conductor end 7 together with the surrounding crimp contact 8, results in a particularly close, and highly electrically conductive connection between the conductor of the cable 1 according to the invention and the crimp contact 8. This creates a uniform contact resistance over the entire circumference of the conductor end.

Ultimately, the design of the electrical conductor according to the invention results, for example, in a pre-assembly of wiring harnesses with crimp contacts of high and consistent quality, which allow for rapid wiring.

The invention is not limited to the exemplary embodiment, and thus is likewise not limited to the use of the cable 1 according to the invention in automotive engineering. Further usage possibilities include, for example, the aviation industry mentioned above, as well as the broad field of data transmission.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A tension-resistant electrical conductor comprising:
a central core wire; and
at least a first inner wire layer and a second outer wire layer arranged over the central core wire,
wherein the central core wire is made of copper or a copper alloy,
wherein the first inner wire layer comprises, in the circumferential direction, an alternating sequence of copper wires and wires having higher tensile strength, arranged over the central core wire, and
wherein the second outer wire layer, and any further outer wire layer, is composed exclusively of copper wires.

2. The tension-resistant electrical conductor according to claim 1, wherein the wires having higher tensile strength are steel wires.

3. The tension-resistant electrical conductor according to claim 1, wherein the wires having higher tensile strength are high-alloyed copper wires.

4. The tension-resistant electrical conductor according to claim 1, wherein at least the central core wire is a bare copper wire.

5. The tension-resistant electrical conductor according to claim 1, wherein the copper wires are nickel plated, tin plated, or silver plated.

6. The tension-resistant electrical conductor according to claim 2, wherein the steel wires are produced from stainless steel.

7. The tension-resistant electrical conductor according to claim 1, wherein a crimp contact is provided at one or both of the ends of the tension-resistant electrical conductor.

8. The tension-resistant electrical conductor according to claim 7, wherein the crimp contact is provided by way of a gas-tight crimp connection between the wires of the electrical conductor and the crimp contact.

9. The tension-resistant conductor according to claim 1, comprising steel wires in the inner first layer, wherein the tensile force thereof is at least 200 N.

10. The tension-resistant conductor according to claim 1, further comprising a high-temperature resistant insulator, wherein the insulator comprises a fluoropolymer.

11. The tension-resistant electrical conductor according to claim 10, wherein the fluoropolymer of the insulator is a polytetrafluoroethylene.

12. The tension-resistant electrical conductor according to claim 1, wherein the alternating sequence of copper wires and wires having higher tensile strength of the first inner wire layer comprises exactly three copper wires and exactly three wires having higher tensile strength.

13. The tension-resistant electrical conductor according to claim 12, wherein the second outer wire layer composed exclusively of copper wires comprises twelve copper wires.

14. The tension-resistant electrical conductor according to claim 1, wherein the wires having higher tensile strength are stainless steel wires having a tensile force of at least 200 N.

15. The tension-resistant electrical conductor according to claim 14, wherein the copper wires are nickel plated, tin plated, or silver plated.

16. The tension-resistant conductor according to claim 15, further comprising a high-temperature resistant fluoropolymer insulation over the outer wire layer.

17. The tension-resistant electrical conductor according to claim 16, wherein a crimp contact is provided at an end of the tension-resistant electrical conductor.

18. The tension-resistant electrical conductor according to claim 17, wherein the crimp contact comprises a gas-tight crimp connection between the wires of the electrical conductor and the crimp contact.

19. The tension-resistant electrical conductor according to claim 18, wherein the alternating sequence of copper wires and wires having higher tensile strength of the first inner wire layer comprises exactly three copper wires and exactly three wires having higher tensile strength.

20. The tension-resistant electrical conductor according to claim 19, wherein the second outer wire layer composed exclusively of copper wires comprises twelve copper wires.
